(19) United States
(12) Patent Application Publication
(10) Pub. No.: US 2022/0339642 A1
(43) Pub. Date: Oct. 27, 2022

(54) METHOD FOR REDISTRIBUTING A FLAKE MATERIAL INTO AT LEAST TWO FLAKE SIZE FRACTIONS

(71) Applicant: Grafren AB, Linköping (SE)

(72) Inventors: Erik Khranovskyy, Linköping (SE); Mykhailo Zhybak, Linköping (SE)

(21) Appl. No.: 17/622,162

(22) PCT Filed: Jun. 26, 2020
(86) PCT No.: PCT/EP2020/068127

§ 371 Date: Dec. 22, 2021

(30) Foreign Application Priority Data
Jun. 28, 2019 (SE) 1950819-1

(51) Int. Cl. B03D 1/24; B03D 1/02; B03D 1/06; C01B 32/194; C01B 32/198

(52) U.S. Cl. CPC B03D 1/245; B03D 1/028; B03D 1/06; C01B 32/194; C01B 32/198; C01B 2204/04; C01B 2204/32; C01P 2004/54

(57) ABSTRACT

The present disclosure provides a method for redistributing a flake material, in particular a two-dimensional nano flake material, into at least two flake size fractions, each of which having smaller flake size variance than the flake material. The method comprises providing a dispersion of the flake material in a liquid, wherein the flake material is not atomized in the liquid, arranging the dispersion in a container, percolating gas bubbles upwardly through the dispersion, for a time sufficient to allow the flake material to redistribute itself in the liquid with larger sized flakes higher up in the liquid and smaller sized flakes lower down in the liquid, and extracting at least one of the flake fractions from a limited vertical level of the container.

### TECHNICAL FIELD

The present disclosure relates to a method of providing a flake material, in particular a nano flake material, such as graphene or graphene oxide, having a limited flake size variance.

### BACKGROUND

Recently the whole family of new materials has been discovered, called two-dimensional (2D) materials. These are substances, which are inorganic, have a crystalline nature but are only a few nanometers thin. Being that thin, 2D materials are approaching the ultimate case of single atom layer thickness.

These materials possess number of unique properties, distinct from their bulk counterparts, due to the low dimension and expected quantum phenomena as well as high surface area effects. 2D materials can be formed by a single element (e.g. graphene, graphene oxide, boron carbon nitride, borophene, stanene, silicene, germanene etc) or complexed ones, including two (hBN, MXenes, MoO₃, WO₃, MoS₂, WS₂, MoSe₂, WSe₂ and other chalcogenides and dichalcogenides, layered oxides) or more elements (LaNb₂O₇, Ca₂Ta₂tiO₁₀, perovskite-type, hydroxides etc).

At present there are mainly two approaches for 2D materials production: i) bottom-up approach—where 2D layer is grown or synthesized from the respective precursors or ii) top-down approach—where the bulk crystals are exfoliated into a single atomic layers crystals—called flakes or 2D materials flakes. The following 2D materials can be synthesized by top-down approach:

G, Go, CrPS4, CrGeTe3, CrSiTe3, MnPSe3, ReSe2, Ta2NiS5, Ta2NiSe5, Bi2Se3, BN, ReS2, FeSe, GaSe, hMoS2, MoSe2, WS2, WSe2, CdPS3, HfS2, HfSe2, InSe, PtSe2, TiS3, PtS2, SnS2, TaSe2, TiS2, ZrS2, ZrSe2, MoTe2, NiS2, NiSe2, WTe2, Bi2Te3, GaTe, MnPS3, BiI3, V2O5, PdSe2, ZnPS3, MoO3, HfTe3, RuCl3, SnO, P, SnSe, NiPS3, C3N4, FePS3 Ca2N, WO3, MoS2, Ge, Si.

It has to be noticed, that not all 2D materials are stable in ambient conditions or in a water based solution.

Within top-down approach different impacts can be utilized for controlled destroying of the bulk mother crystal and breaking the chemical bonds between the layers—mechanical, chemical or their combination. This results in several issues affecting material quality and outcome. First, none of the existing technology at present can provide reliable exfoliation of specifically single layer, producing sometimes 2, 3 and up to 10 layers flakes mixture. This issue is addressed further by additional post-processing via ultrasonication. However, the issue still exist for many 2D materials, technologies as well as manufacturers.

Second, the mechanical impact on bulk crystal allows to exfoliate single atomic layer of material, but the lateral size of the new 2D flake is limited to the size of mother single crystal. Furthermore, quite often during the exfoliation flakes are broken down to even smaller pieces.

Thus, resulting outcome of the 2D materials manufacturing process is a mixture of flakes of diverse thickness and lateral size of flakes.

Concerning the definition “size” it has to be explained in terms of the technology. The flakes which are exfoliated are usually of irregular shape, e.g. round, rectangular, triangular etc., resembling the crystal structure of the mother crystal. Thus, most correct would be to refer to the surface area of the flake. However, commonly flakes are described by their lateral dimension—meaning largest value of either length or width, or diameter of the flake. From here and forward we will use term “size” which is in fact a flake maximal lateral dimension or “flake area” where it is more appropriate.

The most prominent example of 2D material is graphene. It was also the first discovered 2D material, paving the way to the whole family, synthesized later. The most common method for producing graphene is liquid chemical exfoliation, so called Modified Hummers method. In this method foreign agents are intercalated inside of graphite grains, oxidizing the single graphite layers and tearing them apart. Thus, single sheets of graphite are obtained, called graphene flakes. The flakes are however, containing number of functional groups on its surface and are in fact graphene oxide.

Graphene oxide flakes has low electrical and heat conductivity, and therefore their application is limited to reinforcing additives in composites, antibacterial coatings or separation membranes. However, graphene oxide flakes can be further treated chemically—reduced—via essential removal of functional groups from its surface. Application of reduced graphene oxide is much broader, covering microelectronics, printed and flexible electronics, electrodes and heat exchangers in optoelectronics, solar cells coatings and diverse sensors etc.

A problem with graphene flakes as a nanomaterial is that the key properties of it are defined not only by its atomic thickness (single, double or multi layers) but also by its lateral dimensions (length and width for rectangular-like flakes and diameter for round-like flakes). Various applications require uniform distribution of graphene flakes of similar lateral dimension. For example, since heat is best conducted in-plane within graphene, it is required to have number of flakes with large average size—like 50-200 micron. While for printed electronics conditions are even more strict: due to high in-plane electrical conductivity graphene flakes have to be as large as possible. But at the same time since diameter of the ink-jet nozzle is limited to 1-3 micron, thus the flakes size should not exceed these diameter, in order to avoid fouling and clogging. Furthermore, flakes of graphene with dimensions ranged from 1 micron down to 50 nm may have still unknown but potentially detrimental impact on biological objects. Thus, graphene flakes of these small size should not be used for certain applications. Finally, graphene flakes with size less than 100 nm is usually called nanographene and may have totally different properties from pristine graphene, due to potential nanoscale and quantum size confinement phenomena occurring at such low dimensions.

The above described issues of flakes size control importance are for graphene, but they are the same importance for any other 2D material, being a natural characteristic of the 2D material quality.

It is important that initially the graphene, as well as any other 2D material flakes size is defined by the size of single crystal grain used as a precursor. However, during the process of synthesis and further treatment, including ultra-sonication, the flakes of graphene oxide can be uncontrolled broken into smaller flakes. Thus, most of the graphene oxide and graphene flakes product on the market are in fact mixture of flakes with rather wide range of lateral dimensions. This already have resulted in number of failed experiments and are a crucial obstacle for further progress of 2D materials in flakes for commercialization and acceptance by the industry. Simply because, the results will be always mitigated and detrimentally affected by to wide size distribution and averaged properties and therefore compromised in not worsening the potential product performance.

At present there are several approaches for obtaining the flakes of graphene oxide of defined size. First, the most reliable method is to use large flakes of size around 100-200 microns and simply break then down to smaller pieces by ultrasonication, controlling the power and time of treatment. In spite its acceptable performance, the approach cannot be practically accepted in the industry, since large graphene flakes production is too expensive and cannot be used as precursors for mass production of smaller flakes graphene

Another approach for obtaining the graphene oxide flakes of required size is gravity based approach such as centrifugation. In the U.S. Pat. No. 8,852,444B2 this has been used, but it only separates graphene flakes by their thickness. However, though graphene flakes of different size indeed has different weight and can be centrifuged, there are at last two powerful obstacles, preventing this approach to be industrially accepted. First, usually the initial mixture of graphene oxide flakes in water contains certain percent of tiny unreacted graphite grains, of different size, down to tens of nanometers. These “nanograins”, being in fact bulk material, are heavier than flakes of the same size and could have been centrifuged efficiently from the dispersion. However, it does not happen simply because of concentration of graphene flakes—flakes are catching grains on their way down and are jammed and wrapped together, disabling the separation by centrifugation. And second, due to large lateral size of graphene flakes, efficient centrifugation can be applied only for very low graphene oxide dispersions, like 0.001 g/L, which is 1000 times less than necessary and practically required dispersions concentrations. Thus, the yield of graphene flakes from centrifugation will be too low to be considered practically acceptable for industry.

Finally, graphene oxide flakes of different size can be in principle separated by filtration as is done in article “Advanced Materials 2015, 27, 24, 3654-3660” using the certain filter pore size, e. g. 10, 1 or 0.2 micron. This, however, is again obstacled by the nature of two-dimensional flakes—thin sheets of material. The flakes which are larger than filter pore size are immediately coating the filter, clogging it and fouling it. Thus, the total yield of this approach is negligible and can be used for extremely low concentrations of dispersions, there is a need for efficient and mass-production compatible method for sorting, separation of graphene oxide flakes based on their lateral size.

The article “RSC Adv., 2016, 6, 74053-74060 DOI:10.1039/C6RA16363G” discloses a method wherein “Size fractionation of graphene oxide sheets assisted by circular flow and their graphene aerogels with size-dependent adsorption”. However, this technique only succeeded in separating the GO-flakes into three size ranges in a rather low concentration of dispersion.

Hence, there remains a need for a method through which larger volumes of well controlled, narrow size-distribution flakes of 2D materials can be produced.

### SUMMARY

An object of the present disclosure is to provide a method of obtaining a two-dimensional material having narrow flakes size distribution at a reduced cost. A particular object is to provide graphene flakes having a narrow size distribution at a reduced cost.

According to a first aspect, there is provided a method for redistributing a flake material, in particular a two-dimensional nano flake material, into at least two flake size fractions, each of which having smaller flake size variance than the flake material. The method comprises providing a dispersion of the flake material in a liquid, wherein the flake material is not atomized in the liquid, arranging the dispersion in a container, percolating gas bubbles upwardly through the dispersion, for a time sufficient to allow the flake material to redistribute itself continuously in the liquid with larger sized flakes higher up in the liquid and smaller sized flakes lower down in the liquid, and extracting at least one of the flake fractions from a limited vertical level of the container.

The invention is based on the fact that gas bubbles will propel solids struck by the bubbles upwardly through the dispersion. Larger flakes in the dispersion will more often be struck by bubbles than smaller flakes.

Consequently, after some time, an equilibrium will be reached, where flakes are redistributed continuously by flake size, with larger flakes at higher vertical levels in the dispersion and smaller flakes at lower vertical levels in the dispersion.

Hence, at each vertical level in the dispersion, flakes having a certain size can be found, with a narrower flake size variance than in the original flake material.

The flake material may present an average thickness of 0.1 to 2 nm, 2 to 20 nm, or 20 to 100 nm.

The thickness typically depends on the number of atomic layers and on the type of the material.

The flake material may present an average flake size, as measured by flake surface area, in the range of 25 to 2500 nm² or 2500 to 250 000 nm² or 0.25 to 25 μm² or 25 to 2500 μm² or 2500 to 40 000 μm².

The flake material may preset a flake lateral dimension to thickness ratio of about 50-500, 500-50 000, 50 000 to 500 000 or 500 000 to 2 000 000.

The flake material may have a density which is equal to or lower than a density of the liquid, said flake material density preferably being 70%-100%, more preferably 90%-100%, of the density of the liquid.

Alternatively, the flake material may have a density which is greater than a density of the liquid said flake material density preferably being 100%-150%, more preferably 100%-110%, of the density of the liquid.

The flake material may consist essentially of graphene and/or graphene oxide.

The container may present a substantially constant cross sectional area as seen in a horizontal plane.

The container may present a height which is at least 4 times, preferably 4 to 10 times, 10 to 100 times or 10-100 times, that of a greatest diameter of the cross sectional area.

The liquid may comprise water.

The flake material may be present in the liquid in an amount corresponding to 1 to 4, or 4 to 10 g/dm³ of the liquid.

The gas bubbles may present an average diameter of 200 nm-100 μm, preferably 200 nm-1000 nm, on release to the dispersion.

A flake size to gas bubble size ratio may be 0.00005 to 0.025, preferably 0.025 to 2, 2 to 100, or 100 to 1000.

In any case the gas bubbles may present an average diameter of 200 nm to 100 μm and the flakes present a maximum lateral dimension of 5 to 200 μm.

The gas bubbles may be supplied in an amount of 5 to 25 ml/min/cm² of cross-sectional area of the container.

The percolating may be continued until equilibrium has been reached, preferably for one hour per 10 cm of container height.

Time to reach the equilibrium depends on the height of the container, and may be estimated as 1 hour per 10 cm of the containers height.

At least some of the flake material may be introduced into the liquid, in the form of a supply liquid dispersion having a flake material higher concentration than the liquid dispersion processed in the container, at a specific vertical level.

For example, the supply liquid dispersion may be introduced at a vertical level which is below a surface of the dispersion in the container, but above a bottom of the container.

As non-limiting examples, the introduction of the supply liquid dispersion may take place at a vertical level which is at between 10-20% of the dispersion depth, between 20-30% of the dispersion depth, between 30-40% of the dispersion depth, between 40-50% of the dispersion depth, between 50-60% of the dispersion depth, between 60-70% of the dispersion depth, between 70-80% of the dispersion depth, or between 80-90% of the dispersion depth.

The extracting may comprise extracting a first flake fraction by extracting the liquid dispersion down to a first vertical level in the container, and subsequently extracting a second flake fraction by further extracting the liquid dispersion down to a second vertical level in the container.

The extracting may comprise freezing of the liquid in the container, or operation of a plurality of valves arranged at spaced apart vertical levels of the container.

The method may further comprise subjecting an extracted flakes fraction to a second redistribution step comprising providing a second liquid dispersion of the flake fraction in a second liquid, arranging the second liquid dispersion in a second container, percolating gas bubbles upwardly through the second liquid dispersion, for a time sufficient to allow the flake material in the second liquid dispersion to redistribute itself in the second liquid with larger sized flakes higher up in the liquid and smaller sized flakes lower down in the liquid, and extracting at least one of the flake fractions from a limited vertical level of the second container.

The method may further comprise estimating a flake size or flake size distribution at a selected vertical level in the contain determining whether the flake size or flake size distribution meets a criterion, and if not, then agitating the dispersion in at least part of the container, repeating the percolating step, repeating the estimating step and repeating the determining step.

The criterion may be related to the average size and/or size distribution of the flakes at that level.

Agitating the dispersion may comprise stirring or vibrating the dispersion.

The method may further comprise estimating a flake size or flake size distribution at a selected vertical level in the container, determining whether the flake size or flake size distribution meets a criterion, an if not, then adjusting a supply parameter of the gas bubbles, repeating the percolating step, repeating the estimating step and repeating the determining step.

The adjusting may comprise adjusting a gas supply pressure or a gas supply rate.

The estimating step may comprise extracting a sample of the dispersion at the selected vertical level, analyzing the sample to determine the flake size or flake size distribution.

According to a second aspect, there is provided a system comprising a container, having a bubble former at a lower portion thereof; a dispersion, received in the container and comprising a flake material and a liquid, wherein the flake material is non-soluble in the liquid, a gas supply, operatively connected to the bubble former, such that gas bubbles percolate upwardly through the liquid from the bubble former; and an extraction device for extracting at least one flake fraction from a limited vertical level of the container. The flake material is distributed in the liquid with larger sized flakes higher up in the liquid and smaller sized flakes lower down in the liquid.

The bubble former may comprise a porous surface having an extent, which preferably corresponds to about 70-95% of an extent of a horizontal cross sectional area of the container.

The porous surface may have a porosity of 0.1-10% by area and 1 to 10, or 10 to 100, or 100 to 1000 openings per mm².

The porous surface may present pores having a diameter of 0.1 to 1 μm or 1 to 30 μm, preferably 1-20 microns or 5-10 microns.

The extraction device comprises an array of openable outlets positioned at spaced-apart vertical levels, each outlet being connectable to a respective secondary container.

The secondary container may be a further container for performing a further percolation step. Alternatively, the second container may be a packaging container.

The extraction device may comprise an extraction holder arranged to control a vertical height at which dispersion to be extracted is pumped out.

The system may further comprise an inlet device, for introducing the flake materials liquid solution into the container.

The inlet device may comprise an inlet holder arranged to control a vertical height at which dispersion to added is introduced.

According to a third aspect, there is provided use of a system as described above, for redistributing a flake material into at least two flake fractions, each of which having smaller flake size variance than the flake material.

In the use, the flake material may consist essentially of graphene and/or graphene oxide.

### BRIEF DESCRIPTION OF THE DRAWINGS

FIG. 1 illustrates a basic flotation system, in perspective view, before gas bubbles have been supplied. The gravity forces pushing the flakes of any size downwards are shown.

FIG. 2 illustrates a side view of a flotation system, wherein a container is filled with polydisperse dispersion of two-dimensional material.

FIG. 3 illustrates an input part of a flotation system, as seen in a bottom view. The openings of certain diameter for gas introduction are shown.

FIG. 4 illustrates an output part of a flotation system, as seen in a top view. The output part is an open polydisperse surface.

FIG. 5 displays examples of the flakes and gas bubbles, of certain size, and Illustrate the principle of invention, which is based on the fact that larger flakes have higher probability of being contacted and pushed up by the bubbles, thus providing redistribution of the flakes in the container after certain time.

FIGS. 6a-6n illustrate the stages of the flakes redistribution depending on their size, illustrating all the forces involved.

FIG. 7 illustrates a flotation system, in perspective view, wherein a container is filled with a polydisperse dispersion of flakes, randomly distributed, after bubble flows have been introduced.

FIG. 8 illustrates a side view of a flotation system, wherein a container is filled with a polydisperse dispersion of nanoparticles, randomly distributed, after bubble flows have been introduced.

FIG. 9 illustrates a container 14 filled with flakes of varying sizes, it shows the upper- middle- and lower-parts referred to in the description.

FIG. 10 illustrates a container 14 filled with flakes of varying sizes, it shows means to move liquids from different vertical levels, and it has several outputs, referred to in the description.

FIG. 11 illustrates an assembly where at least one similar apparatus is connected to the output of a prior one, thereby further refining the separation/distribution in a section already processed by the first apparatus.

FIGS. 12a-12h illustrate the case where polydisperse solution is introduced in the middle part of the container and the steps according to the process of flakes redistribution based on their size.

### DETAILED DESCRIPTION

The invention provides a technique for redistributing flake material in a liquid dispersion according to the flakes surface area (flake size). Flake size is a scalable property, wherein a greater flake size, increases the bubbles probability to be met and adhere to the flake, thus causing the flakes to ascend, upwardly through the liquid, such that larger flakes tend to accumulate at a higher vertical level than smaller flakes. Said tendency is hereby designated floatability, and the floatability is positively dependent on the flake size, with is utilized in some of the embodiments. It should also be noted that the terms particle, flake and flake material can be used interchangedly since different terms might be descriptive in the context.

Furthermore, if used particle-material has a higher density than the liquid, and the bubble flow is pointing upward, the particles will start sinking when unattached to the bubbles, thereby counteract the bubble flow, further magnifying the separation between particles of differing properties. This technique can be of great value in contexts where other separation techniques are not possible or reasonable.

Liquid dispersions of Graphene oxide (GO): One very suitable area of use, where also the tendency-affecting-properties are highly scalable, is the separation of aqueous dispersions of graphene oxide flakes, with respect to flake size. The size obviously is scalable. In this context other techniques like ex filtering can at the best achieve discretely distributed separation, while still comprising several other drawbacks like filter clogging etc (se ex background section). A graphene oxide dispersion with few other affecting properties, like differing thickness etc, can be prepared. By ultra-sonication of the dispersion, the differing thickness can be substantially removed and only single layer flakes are present. Increased surface area of the flake increases the particles attachability, and a larger area obviously increases the possibility of the bubbles encountering the flake, therefore also the possibility of getting attached. Furthermore, the graphene oxide flakes have a negative buoyancy in water.

No matter what the reason, through empirical testing's of polydisperse graphene oxide flakes, with flake sizes between 0,005 to 10 μm and bubble-diameters of 10 μm, it seems like large flake sizes averagely move faster upwards than smaller, if defining velocity by how far they moved after a period of time including movements both up and down, not by specifically comparing the temporary velocity when being attached to a bubble. Thus in tested prototypes using graphene oxide flakes of nanodimensions with microbubbles, it seems like the defined average-upward-velocity is positively dependent on the flakes flake sizes, with is also utilized in some of the embodiments.

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention.

The technique will hereby be described in greater detail. The technique is often described in combination with graphene oxide flakes, but it is obvious for a person skilled in the art, that the same technique could be applied to other two-dimensional materials with suitable properties. However, in the context of filtering/separating an “aqueous dispersions of graphene oxide flakes in”, it solves a problem, previously considered as very difficult. Furthermore, the invention is most thoroughly tested in this context. With empirical tests, it has been established that the technique works, and during this process optimal configurations have been developed. Due to this the preferred embodiment is described in conjunction with a “aqueous dispersion of graphene oxide flakes”, even though it can be applied in many other contexts.

However most of the processes have been tested using Graphene Oxide flakes, wherein pristine graphene oxide has been processed (ultra-sonicated or similar) to become substantially single layered. They can sometimes be double layered or triple-layered but should be processed to, to very rarely have more than this. Therefore, when we talk about size, we are actually referring to their maximal lateral dimension, either width of length of the flake in any direction. It is in other words the surface area-size we referrer to, since they all have negligible thickness. This also applies to other particles used, in combination with the described technique.

A flake material is a material which has one dimension, designated thickness dimension, which is substantially smaller than the other two, designated surface dimensions. It is often referred to as two dimensional materials. Flake size is measured by the surface-area-size defined by said surface dimensions of the flake, having substantially larger dimensions than said thickness dimension. Flake thickness is measured by the dimension of said thickness dimension which is substantially smaller than the other two. A nano flake material or “flake nanomaterial” is a material that has at least one nanometric dimension, i.e. a dimension that is 1-10 nm. For the present disclosure, the flakes typically have a thickness which is nanometric and surface dimensions ranging between nanometric and micrometric dimensions.

A liquid dispersion here refers to a liquid comprising particle of another material. Due to classification problems, the wording dissolved or undissolved is omitted. When it comes to aqueous dispersions of graphene oxide flakes for example, the flakes actually create bounding's to the water, which according to some descriptions on the web, should be classified as being dissolved. However often, when referring to a material dissolved in liquid, an atomization of said material is assumed, which usually isn't the case with GO-flakes. To avoid this misunderstanding those words are omitted. In a few sections the term un-atomized has been used instead. Furthermore, when comparing densities of liquids and material in the liquid dispersions we refer to the liquid excluding the material, not including.

The invention provides a technique for redistributing flake material in a liquid dispersion according to their surface area size. It operates according to the principle that minuscule gas bubbles, in particular microbubbles or smaller, hit and to some extent attach to, flakes present in the liquid, thus causing the flakes to float. The greater the flake size, the likelier bubbles are to hit and adhere to the flake, thus forcing the flake upwardly through the liquid, such that larger flakes accumulate at a higher vertical level than smaller flakes.

The invention has proven to provide a continuum of flake sizes, from the smallest ones at the lower level in the container to the largest ones at the higher levels in the container. In particular the technique has been thoroughly tested for redistribution of aqueous dispersions comprising graphene oxide (GO) flakes of nanometric dimensions, which are particularly suitable since larger flake sizes there gets increased attachability. It thereby can provide the market with a well needed supply of GO flakes with very precise sizes.

With the introduction of upwardly moving bubbles into the liquid dispersion a new state is created giving the flakes different properties. The flakes aren't solely affected by the force of gravity but periodically also by an upward force when attached to the bubbles. The bubbles obviously get more positive buoyancy when attached to upwardly moving bubbles. Larger flake sizes encounter bubbles more and, considering aqueous dispersions of GO flakes, also become more adherent. These two component together defined as increased attachability. It has been shown, that in some circumstances, that flakes with proportionally larger time part of positive buoyancy tend to accumulate higher up in the container, which is hereby defined as increased floatability. In the above defined liquid state, some flakes initially tend to ascend and some to descend, the average velocity being dependent on how long the upward respective downwards periods are. The average velocity is therefore closely dependent on the flakes floatability, and is referred to as average velocity in the document. After a certain amount of time they tend to stabilize in a certain vertical position.

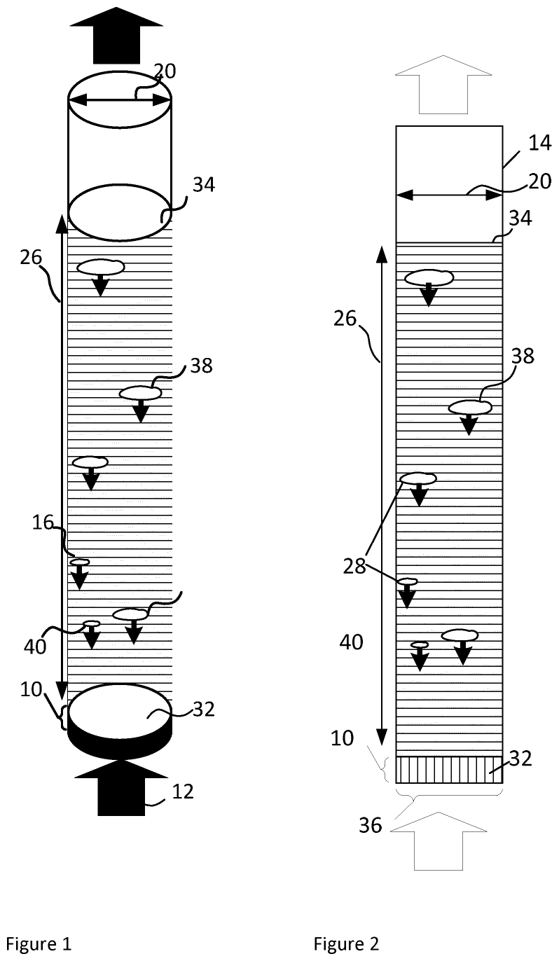

In a basic embodiment, the described technique is performed can use a modified flotation system according to FIG. 1 and FIG. 2:

The system comprising:

a container 14, having a bubble former 10 at a lower portion thereof;

a liquid dispersion 16, received in the container comprising a flake material 28 and a liquid,

a gas supply 12, operatively connected to the bubble former 10, such that gas bubbles percolate upwardly through the liquid from the bubble former 10, and

an extraction device, not shown in the figure, for extracting at least one flake fraction from a limited vertical level of the container,

wherein the flake material is distributed in the liquid with larger flake sizes 38 higher up in the liquid and smaller flake sizes 40 lower down in the liquid.

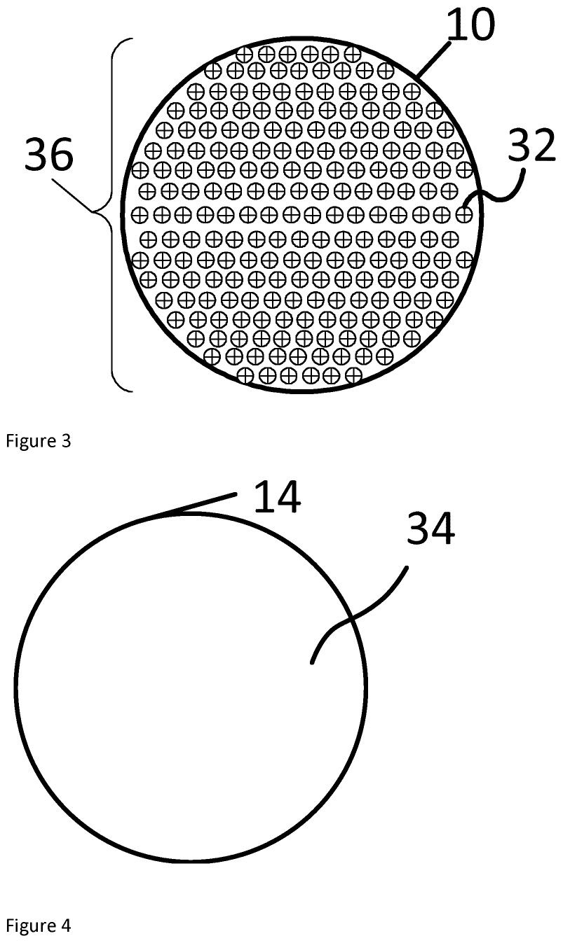

The bubble former 10 of the system (see FIG. 3), are configured, to supply bubbles substantially uniformly distributed across a horizontal container-cross-section, without totally covering the cross-section with bubbles. Preferably it should supply the container with bubbles of such characteristics comprising velocity, size, amount and concentration per area, so that there is possibility for a flake of the flake material in the container to be touched by the bubbles, but still a risk for flakes to be missed or not attaching. The greater the flake size, the more bubbles are likely to hit and, due to surface tension, adhere to the flake, thus forcing the flake upwardly through the liquid. Thus large flake sizes accumulate at a higher vertical level than smaller flakes. The variation in flake size, in combination with described bubble-characteristics preferably should be of such a level that, the proportion of time larger flakes averagely interact with the bubbles can be distinguished from the proportion of time smaller flakes interact.

The bubble former 10 can advantageously comprise a porous surface having an extent, which corresponds to about 70-95% of an extent of a horizontal cross sectional area of the container.

The porous surface can have a porosity of 0.1-10% by area and 1 to 10, or 10 to 100, or 100 to −1000 openings per mm², and the former pores 32 often have a diameter of 0.1 to 1 μm or 1 to −30 μm, preferably 1-20 microns or 5-10 microns. Liquid dispersions wherein the flake material presents an average thickness of 0.1 to 2 nm, or 2 to 20 nm, or 20 to −100 nm depending on numbers of atomic layers and type of the material, preferably 0.3-1 nm or 1-10 nm, can be used. The technique according any embodiments hereby described, have tested varying flake size to thickness ratios, wherein it has been advantageous when the flake material presents a flake size to thickness ratio ranged of 25 to 2500 nm² or 2500 to 250 000 nm² or 0.25 to 25 μm² or 25 to 2500 μm² or 2500 to −40 000 μm².

Liquid dispersions with varying flake sizes have been tested with adequate performance. Liquid dispersions have been redistributed, wherein the flake material presents an average flake size, as measured by the surface area defined by two flake dimensions being substantially larger than a third dimension, of 0.01 μm²-10000 μm², preferably 1 μm²-200 μm².

When bubbles have a reasonable possibility of attaching as well as not attaching to the particles, you can use the natural differences regarding attachability, within the particle population to be separated, to distribute the particles according to said attachability. Too good attachability for all particles, as well as to bad, impair the possibility to differentiate them. The bubbles should however preferably be small, here classified as microbubbles, and they should be vertically directed upward with low initial velocity.

If the bubbles supplied at a given point of time, totally covers the cross-section, all flakes will encounter bubbles and there will be no difference in probability for interaction comparing large and small sizes. Furthermore, if the bubble beams aren't uniformly distributed across the cross section the parts of the cross sections can be missed piling up particles. Even parts of the cross section having less bubbles or size etc can affect that area to give the particles different properties concerning floatability etc, giving differently expected vertical distributions depending on where on a horizontal cross section you make a sample.

Advantageously bubbles can percolate out from narrow pores 32 on the bubble former 10 at the bottom of the container, forming bubble beams, ascending up through the liquid-dispersion of particles. The liquid dispersion can for example be an liquid-dispersion of graphene oxide flakes, possibly an aqueous dispersion. The concentration of the supplied gas beams per area, is obviously important. If pores 32 are to closely placed horizontally, the percolating gas bubbles could be compared to a gas-wall moving all particles upwards, whereby a regular froth flotation process would be performed, which is not the intention. To sparsely placed pores however, would most likely just make the particles pile up in between the inlets leaving the particles on the bottom after they have sunk down. A properly calibrated beam concentration is therefore important. Consequently, there are also, various recommendations for the bubble characteristics, due to the circumstances. The same can be said about beam velocity, to high velocity will accumulate the flakes near the surface and to low velocity will make them accumulate near the bottom.

Consequently, the bubbles characteristics comprising velocity, size, amount and concentration per area, are important settings. However, they obviously have dependencies, sparsely placed pores 32 are less crucial if they are larger etc., whereby it is difficult to suggest separate settings. Nevertheless, some characteristics staking the outer limits can be prepared.

Testing has shown that the gas bubbles advantageously can present an average diameter of 200 nm-100 μm, preferably 200 nm-1000 nm, on release to the dispersion. The ratio of flake to bubbles size is important parameter and should be in range of 0.00005 to 0.025, or 0.025 to 2, or 2 to 100, or 100 to 1000

Testing has also shown that the gas bubbles advantageously can be supplied in an amount of 5 to 25 ml/min/cm² of cross sectional area of the container.

The relation between liquid density and flake material density obviously is important. When the particles have slightly higher density than the liquid, if neglecting the time it takes to switch direction, flakes are moving up when attached to gas bubbles and flakes are moving down because of gravity, when unattached. Larger flakes interact more often and, at least when using nano-sized GO-flakes, are pushed up for a longer time. Thus the particles within the dispersion tend to interchangeably move up and down, which likely should increase the separation between more and less attached particles. Much to heavy materials could however prevent them from ascending even when attached to a bubble. Therefore, the flakes preferably should be of a density fairly similar but equal to or higher than the liquid, said flake material density preferably being 100%-150%, more preferably 100%-110% of the density of the liquid.

However, the technique is not strictly reserved for materials with these properties, and can be applied on flake materials with a density which is lower than a density of the liquid. Said flake material density should in these cases be 70%-100%, more preferably 90%-100% of the density of the liquid.

In some embodiments, the system can be used for: redistributing a population comprising flakes of flake material, in particular a nano flake material, possibly graphene oxide of any other two-dimensional flake material, into at least two flake fractions, each of which having smaller flake size variance than the flake material, the technique comprising: providing a liquid dispersion 16 comprising the flakes 28 of said material, arranging the dispersion in a container 14, percolating gas bubbles upwardly through the dispersion, for a time sufficient to allow the flake material to redistribute itself in the liquid with larger sized flakes 38 higher up in the liquid and smaller sized flakes 40 lower down in the liquid, and extracting at least one of the flake fractions from a limited vertical level of the container.

It has been shown that after a certain time after which a dynamical equilibrium is established: The flakes are continuously distributed vertically within the container, with the largest flakes closer to the liquid surface, and the smaller flakes closer to the bottom. The flakes are granularly distributed vertically, according to their flake-size, and flakes of substantially the same flake size are lined up on the same vertical level. These results have been produced several times with many different settings.

### The Redistribution Process:

What is hereby defined as redistribution is the automatic vertical reordering of the particles, occurring in the new context arranged by proposed aeration, by which flakes tend to switch position so that large flakes sizes accumulate at the top and smaller further down. Later in the description we present detailed explanation of the process along with the simple simulations, to explain this behavior. The simulation is supposed to show that flakes 28, having less proportion upward time, are likely to leave upper space for flakes 28 with more proportion upward time.

How come not all flake particles moving upwards end up by the surface and all particles moving downwards end up at the bottom. The particles have a tendency to repel each other, and with the introduction of microbubbles into the dispersion, periodically attached to the articles, this tendency is enhanced. Particles attached to bubbles repel each other more. Not all particles with positive upward velocity gather next to the surface, the particles have a natural tendency to spread out and utilize the given space. However, the region closest to the top tend to be crowded by the particles being pushed the most upwards, thus the largest flake sizes, and the region closest to the bottom to the particles being pushed the least upwards, i. e. the smallest flake sizes. A larger surface obviously gets hit more and thus moves upwards with more force. It seems like even though, some small flake sizes 40 initially are located above large flake sizes 38, they get pushed aside by the larger flakes. This isn't so strange since the repelling forces prevent the articles from getting to concentrated/close in one region, leaving space in between particles. This in combination with the fact that small flakes have proportionally more descending time implies that even if small flake sizes 40 initially block the upper space of the container, they leave that spot when falling. With the large flake sizes 38, with more upward time waiting to occupy the spot. However, if this “reordering” doesn't occur when the cross-section area is too large, therefore the concentration of the flake material in the liquid in an amount corresponding from 1 to 10, preferably 1 to 4, or 4 to 10 g/dm³. It should also be noted, that the equilibrium achieved is only during gas bubble flow. Once the flow is stopped, all flakes start to move down. Thus the extraction of graphene flakes with specific size should be done immediately after flow termination.

Obviously the container 14 used to get this redistribution has to be narrow, otherwise the particles can all end up near the surface or bottom, and no good distribution is achieved. Actually for a vertical distribution to be valuable, the distribution of varying flake sizes, should be spread across vertical spans, large enough for each separate flake size to be easily extracted. A narrow container is therefore important. How narrow partially depends on the proportion flake material per volume.

To achieve this the container can presents a substantially constant cross sectional area as seen in a horizontal plane. If we assume this is the case, the container can advantageously presents a height which is at least 4 times, or 4 to 10 times, preferably 10-100 times, the greatest diameter of the cross sectional area.

If said cross-section area is evaluated in relation to the of flake material: the flake material is present in the liquid should be in an amount that is such that a total flake size (surface area) of the flake material is greater than the cross sectional area of the container, wherein the total surface area of the flake material is preferably at least 5-50 times that of the cross sectional area of the container.

If above considerations are applied on liquid dispersions graphene oxide flakes, it is not uncommon that a flake size of interest represent 1% in weight, thus approximately 1% of the area. In this case it obviously is preferred that the cross-section is at least smaller than 1% of the total flake size, to avoid larger or smaller flake sizes from appearing on the same vertical level. Well tested calibrations of the invention, using aqueous dispersions of graphene oxide flakes as well as other similar liquid dispersions, suggest that flake material present in the liquid in an amount corresponding to 1-10 g/dm³, provide working condition.

Another way of expressing it can be, to refer to the flake concentration in the liquid. A reasonable calculation would the suggest that the flake material is present in the liquid in an amount that is such that a total surface area of the largest flake sizes material is greater than the cross sectional area of the container, preferably the liquid surface cross sectional area, since that's where the largest flake sizes will end up. The largest flake sizes should preferably be defined from having a flake size of more than 90% of the largest flake size of the flake material. More preferably said total surface area would be if 5-10 times that of the cross sectional area of the container.

### Result

The hereby described technique can provide flake materials with highly specific flake size. When using graphene oxide nanomaterial flakes, a system or a method according to the hereby described invention can provide the following:

A liquid dispersion comprising a liquid and flakes of graphene oxide, wherein the flakes can present populations with an average flake sizes between 25 nm²-4000 μm², and wherein 95% of the flakes have flake size which differs less than 10% from said average flake size of a specific population.

The liquid dispersion can be provided in concentrations wherein the flakes are present in an amount of 0.1-10 g/dm³ of the liquid dispersion.

Liquid Dispersion State:

To get the required result above a certain Liquid Dispersion State according to liquid dispersions above but further comprising gas bubbles is preferable. The aim is to provide a Liquid Dispersion State. By applying bubbles with the correct characteristics in dispersion with the right characteristics considering un-atomized material and liquid, you can get a new dispersion with the resulting “redistribution-ready” properties. The microbubbles considered as part of the new dispersion, and this dispersion requires constant refill of gas bubbles. The dispersion should be as following:

A liquid dispersion, preferably an aqueous dispersion, composition of matter comprising:

a liquid;

a non-atomized polydisperse substantially one-layered population of graphene oxide flakes, polydisperse with respect to flake size, surface dimensions on the order of nanometres to micrometres; having higher density than the liquid;

and

gas microbubbles, having positive floatability, having dimension on the order of micrometres or lower constantly supplied ascending from below the population;

wherein the combined characteristics of components being such that floatability of the flakes is positively dependent with respect to their flake size.

Several recommended settings regarding flake-, bubble-characteristics, etc. has been supplied above. However, said characteristics are usually mutually dependent, why it is difficult to give recommendations separately. Due to this a method for calibrating them, starting from very basic settings is hereby supplied. By for example regulating the gas-supply, several bubble-characteristics above can be adjusted, without adjusting the solid parts of the system as such. The input pressure of the gas supply 12 can affect both bubble-size and velocity, and is therefore a easy approach

A method for tuning the bubble characteristics in an embodiment according to any of the above embodiments, for regulating supplied pressure, comprising:

a liquid dispersion comprising flake nanomaterial and a liquid, preferably an aqueous dispersion comprising GO-flake nanomaterial. The liquid should preferably be of slightly lower density than the nanomaterial, more preferably between 70% and 100% of the nanomaterial. The bubbles should be set to a size slightly larger than the smallest flake of interest in the dispersion.

Use nanomaterial concentration and bubble-former recommendation according to above.

A. Start supplying bubbles with an input-output-pressure ratio according to recommendations above. A well-calibrated system of container height of 40 cm lasts for about 4 hours, before equilibrium mode is reached, so any immediate visible change in density possibly indicates a too high input pressure. Try getting as a good start pressure as possible.

B. Run bubbles with this specific pressure.

C. operate a couple of hours, preferably 4 hours if liquid has been stirred before step B, where after

a. If almost all flakes are at the bottom of the container, possibly stir the dispersion and increase the pressure and rerun step 2

b. If almost all flakes are at the top of the container, possibly stir the dispersion and decrease the pressure and rerun step 2

c. If neither of the above go to step 4

D. extract sample tests at desired vertical levels

a. If no good separation and possibly not enough time run go to step 3.

b. If no good separation and time must be ok

i. if separation to close to top, possibly stir, decrease pressure, preferably to a pressure somewhere in between current pressure and previously tested maximum pressure among those considered to be low and go to step 2.

ii. If separation to Close to bottom, possibly stir, increase pressure and go to 2.

c. if above steps are run to many times go to step E.

d. If good enough separation achieved save the settings.

E. Rerun step 2-4 according to above, using so far best calibration, but instead of increase/decrease input pressure increase respective decrease the concentration of the flake material.

To Summarize the Redistribution Process:

What is above defined as redistribution is the automatic vertical reordering of the particles, occurring in the new context arranged by proposed aeration, with proposed settings. Even though specific parameters are not always supplied, partially because it is the combination of these parameters that are important, the considerations hereby described should be sufficient for a “person skilled in the art” to utilize the technique. The large flakes have larger chance of getting hit by a bubble. This chance is proportional to their surface area. Furthermore, if assuming GO-nano-sized flakes, they are more likely to attach to a bubble when they get hit. In between getting hit, the gravity will force the flakes to after a while start to sink. By adjusting the bubble flow so that some flake-sizes flow upwards and others flow downwards you get a good spreading in the distribution. It is possible to get a distribution, even with all flake-sizes moving upwards also, but probably the distribution quality will be less good.

When the bubbles are added to the dispersion the repelling forces between the flakes are increased, this means that not all flakes will gather up at on place as much as it would without the bubbles. If it wasn't for this, the flakes with positive average-velocity would end up at the surface, the flakes with negative average-velocity would end up at the bottom, and the ones with zero average-velocity would go up and down at their initial spot. That wouldn't be such a good separation since that would only separate the flakes into 2 or maybe 3 levels. This is not the case. You get the flakes well distributed with the largest on top, and then row by row flakes of decreasing flake size. With the smallest flakes near the bottom. Sometimes with a slightly larger flake among the smaller and wise versa, but on the whole, good separation.

One reason for the above is the increased repelling force. This prevents the particles from getting to close to each other, and this also improves the possibility for the particle to redistribute, the faster particles FP have a greater chance of pushing away a slower particle SP even if the particle SP has reached the top before particle FP arrives there, the separation helps the redistribution process. Imagine a pool table with all the balls tightly packed in a corner. Assume you try removing one ball by shooting at it. Compare this with a case, when all balls are spread out all over the table and you realize, the spreading probably improves the redistribution.

Simple Simulation: Another reason for the redistribution is the following: The flakes aren't constantly going up nor down, but some flakes move upwards more than other. Thus when a small flake size SF with lesser time upwards, blocks a high position, for a larger flake LF with more upwards time, they will switch place if LF moves upwards when SF moves downwards. Imagine these are the only two particles in the system. After this they might, or will, switch position again and again etc, but the average time with LF on top will be longer than the time with SF on top.

If you add more particles like this with several different probabilities, the same interaction between these particles should appear. For simplicity assume that all are in a long column. If you do this, they will start switch places, and slowly redistribute so that more large flakes are higher up. A basic simulation is made in Excel for better explanation (see Table below).

Referring to the Table, top row shows 19 different vertical positions PS1-PS19, PS1 represents the bottom and PS19 the top. On the next row is the possibility for upward-movement is set. Ex 0.95 represents 95% possibility to “want” to move upwards and 5% to “want” to move downwards. “Want” because if the one at the next position is not moving at the same time, there is no place to move to. In other words it is assumed that this is a simulation of a The values 0.95-0.05 at the same time, represent for what kind of particle is placed very narrow vertically elongated column, only having room for one particle per vertical level. On the next row is the randomized outcome, a simple built in function using the above vales (0.95-0.05) as the probability to generate 1. The value 1 means “want” to move up and 0 down. If the particles both want to switch place they do. Referring to row 2 again, 0.95 represents a large flake and 0.05 a very small flake, with 95% respectively 5% of chance of attaching to a bubble, and thereby substantially the same chance of moving upwards. Referring to the flake sizes in liquid GO-dispersions sold at market, and assuming that the possibility of getting hit is proportional to the size, the variations in probabilities used in Table should be fairly sensible. In the following lower row “new positions” the closest upper row “ForceUp(=1)ForceDown(=0)”, every two adjacent columns are evaluated, if the left column is 1 and the right one is 0, the values from 2 rows up are copied and switched between left and right, otherwise, they don't switch and the rightmost cell gets compared with the next right cell instead. Refer to for columns PS7:PS8, where the randomized row “ForceUp(=1)ForceDown(=0)” generates 1:0, therefore these columns values from row 2 have been copied and switched place. In this manner it continues 2 rows by 2 rows, downwards.

| | PS1 | PS2 | PS3 | PS4 | PS5 | PS6 | PS7 | PS8 | PS9 | PS10 |
|---|---|---|---|---|---|---|---|---|---|---|
| Probability of force Up | 1 | 0.9 | 0.9 | 0.8 | 0.8 | 0.7 | 0.7 | 0.6 | 0.6 | 0.5 |
| ForceUp(=1)ForceDown(=0 | 1 | 1 | 1 | 1 | 1 | 0 | 1 | 0 | 1 | 1 |
| [symbol] | | | | | | | | | | |
| New Positions | 1 | 0.9 | 0.9 | 0.8 | 0.7 | 0.8 | 0.6 | 0.7 | 0.6 | 0.5 |
| ForceUp(=1)ForceDown(=0 | 0 | 0 | 0 | 0 | 1 | 1 | 1 | 0 | 1 | 0 |
| [symbol] | | | | | | | | | | |
| hundreds of iterations | | [symbol] | | | | | | [symbol] | | |
| New Positions | 0 | 0.2 | 0.1 | 0.2 | 0.3 | 0.4 | 0.4 | 0.3 | 0.6 | 0.45 |
| ForceUp(=1)ForceDown(=0 | 0 | 0 | 0 | 0 | 1 | 0 | 0 | 0 | 1 | 1 |
| [symbol] | | | | | | | | | | |
| New Positions | 0 | 0.2 | 0.1 | 0.2 | 0.4 | 0.3 | 0.4 | 0.3 | 0.6 | 0.6 |
| ForceUp(=1)ForceDown(=0 | 0 | 0 | 0 | 0 | 0 | 0 | 1 | 0 | 0 | 0 |
| [symbol] | | | | | | | | | | |

| | PS11 | PS12 | PS13 | PS14 | PS15 | PS16 | PS17 | PS18 | PS19 |
|---|---|---|---|---|---|---|---|---|---|
| Probability of force Up | 0.45 | 0.4 | 0.35 | 0.3 | 0.25 | 0.2 | 0.15 | 0.1 | 0.05 |
| ForceUp(=1)ForceDown(=0 | 1 | 0 | 1 | 0 | 0 | 0 | 0 | 0 | 0 |
| [symbol] | | | | | | | | | |
| New Positions | 0.4 | 0.45 | 0.3 | 0.35 | 0.25 | 0.2 | 0.15 | 0.1 | 0.05 |
| ForceUp(=1)ForceDown(=0 | 1 | 1 | 1 | 1 | 1 | 1 | 1 | 1 | 0 |
| [symbol] | | | | | | | | | |
| hundreds of iterations | | | | [symbol] | | | | | |
| New Positions | 0.6 | 0.5 | 0.65 | 0.7 | 0.9 | 0.85 | 0.8 | 0.75 | 0.95 |
| ForceUp(=1)ForceDown(=0 | 0 | 1 | 0 | 1 | 1 | 1 | 1 | 0 | 1 |
| [symbol] | | | | | | | | | |
| New Positions | 0.45 | 0.65 | 0.5 | 0.7 | 0.9 | 0.85 | 0.75 | 0.8 | 0.95 |
| ForceUp(=1)ForceDown(=0 | 0 | 1 | 0 | 0 | 1 | 0 | 0 | 1 | 1 |
| [symbol] | | | | | | | | | |

[symbol]

indicates data missing or illegible when filed

As can be seen, the flakes initially are placed in the more or less opposite order to compared to how they end up, with the largest in the bottom and the smallest on the top. The simulation is then run in 200 iterations. After this the resulting order was as in the row next from the bottom in the Table. In other words the large flakes that move upwards a lot will, to a larger extent end up in the top, this is also what the test results show. It should be noted, that this only corresponds to one flake for each size. If you run this a number of times, you often slightly different values, but on the whole it gives quite a secure result. Important to note is also, that this corresponds to the case when, there only is enough space for one flake per level. If there would be enough room for all flakes at the top, all upward going flakes would end up there, the same applies for the bottom.

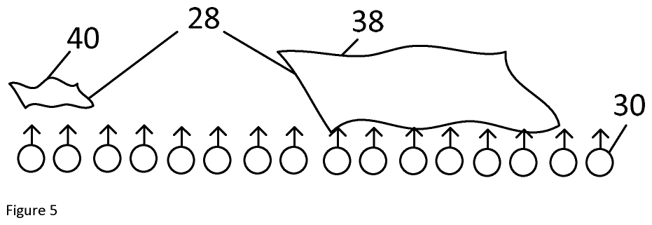

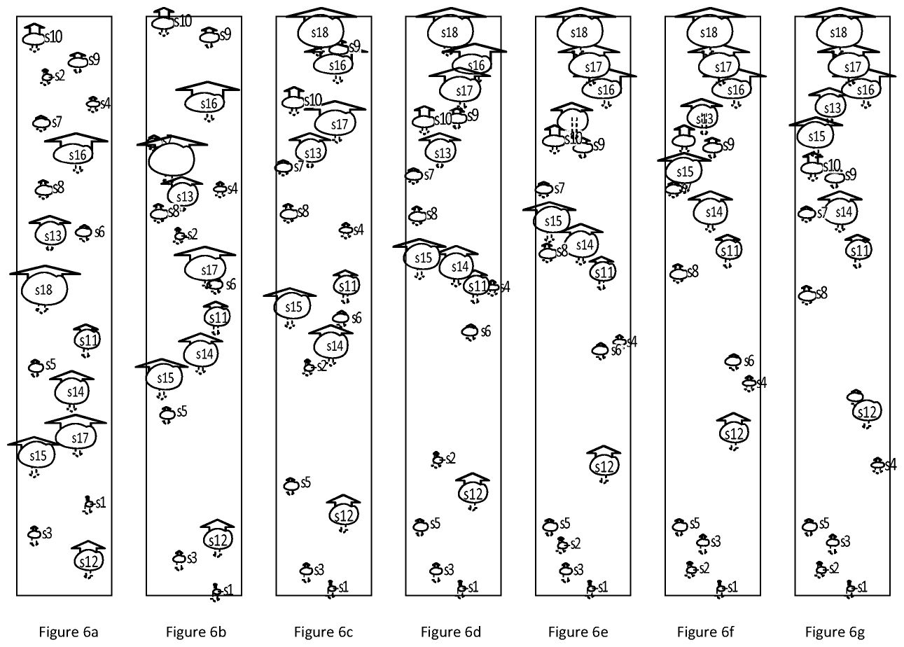

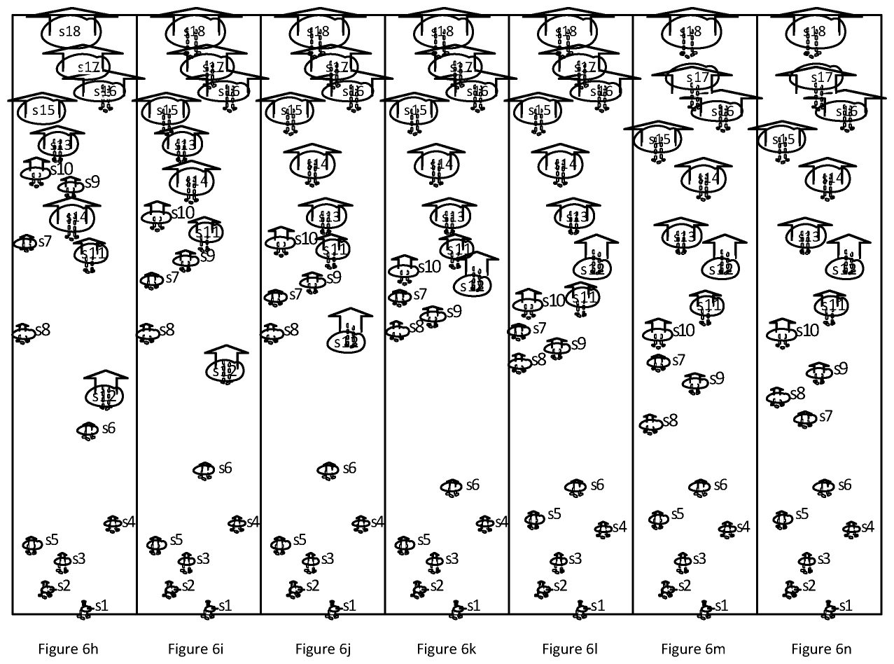

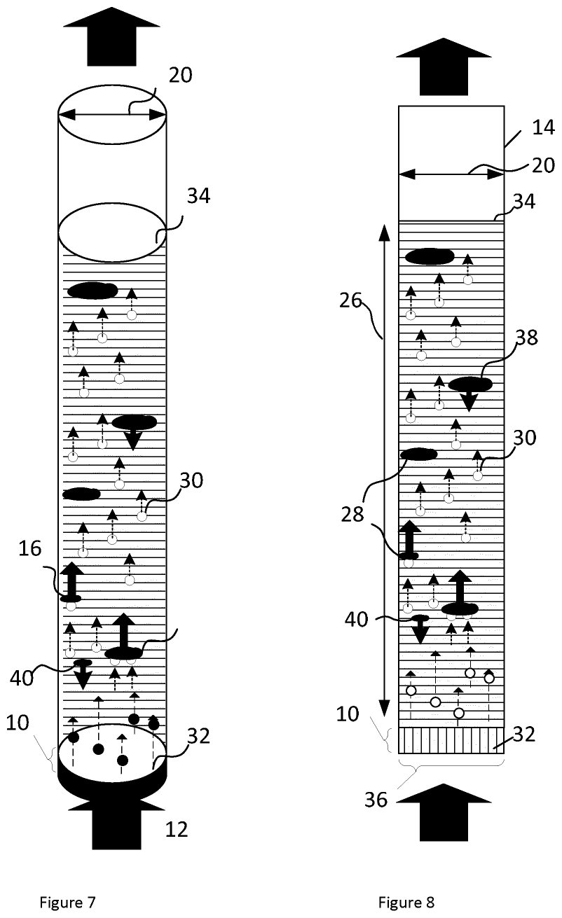

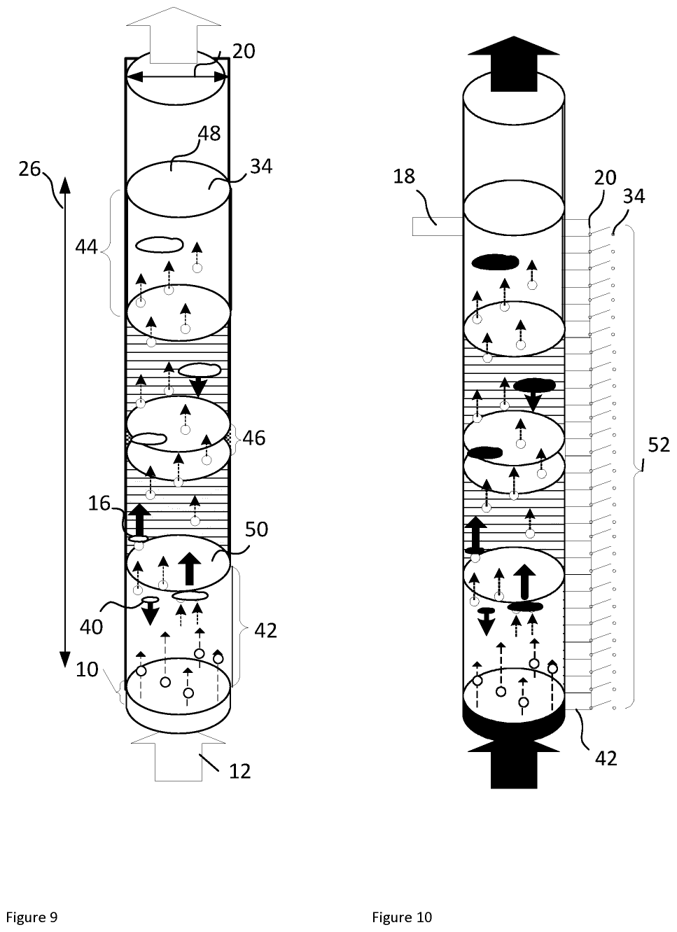

Referring to FIGS. 6a-6n, is a simplified description of how the redistribution might occur. If it is an embodiment where the average upwards velocity as well as the floatability is positively dependent on the flake size when supplied with an ascending stream of bubbles, more likely to hit and attach to larger flakes. Further it is assumed that the container is so narrow as to be sufficient for only one bubble attached to a particle, but when a particle detach from a bubble it will be small enough to pass by a bubble when descending. The bubbles aren't shown but, the particle's increased floatability is illustrated with wider arrows upwards. The gravity is illustrated as dotted arrows downwards, and if floatability is considered positive, the upwards arrow should be larger than the downwards arrow. The difference in average-velocity is illustrated in how far a particle is moving in open space per figure. If a particle is blocking another the logic described, should be sufficient to explain if they switch place or not. In this example highest probability is assumed to always rule. The size of the particles, and therefore the size of the floatability and upward velocity is described by the particles name of increasing numbered values (s1 to s18) according to their size. The FIGS. 6a-6n, are not to be considered as scientific or all through correct but are merely a simplified way of trying to describe, what is assumed to happen, in the invention when we get the prototype- and simulation-results substantially equivalent to the initial and final figure. Once again it should be mentioned all illustrations of the drawings are for the purpose of describing selected versions of the present invention and are not intended to limit the scope of the present invention. The present invention is to be described in detail and is provided in a manner that establishes a thorough understanding of the present invention. That being said, together with the former description within this section, no further explanation is considered to be needed for the FIGS. 6a-6n.

Regarding the settings: Due to the fact that regular flotation technique is so well known and utilized, there are recommendations and simulations designed to calculate the optimal settings of these properties. Due to the fact that regular flotation techniques aims to filter out all particles, neither the flotation-optimal-settings nor flotation-worst-settings should be optimal for the proposed technique of this invention. The optimal settings for froth flotation would likely, bring all material to the surface and worst settings would let the particles sink to the bottom. The optimal settings for this invention would end somewhere in between.

### First Embodiment

Therefore, it can be of value to have a system according to the one described, can further be comprising: A flotation system, further characterized in that:

the liquid-container 14 has a upper part 44, at a vertical span continuously traversing down from the liquid surface, wherein the containers 14 inner horizontal cross-sections area is too small in size for all flake materials, preferable nanomaterials, with positive floatability to fit on the same vertical level, and preferably have to be spread over several separately extractable vertical levels, and more preferably being so narrow throughout it's height that acquired distribution with respect to flake size will be spread across such a considerable vertical span that a desired flake size easily can be extracted from a specific vertical level. In this way you can assume that for example

If the system intend to redistribute flakes of negative floatability/upward velocity it is advantageous if the liquid-container 14 has a lower part 42, at a vertical span continuously traversing up from the container bottom, wherein the containers inner horizontal cross-sections area is too small in size for all flakes with negative floatability to fit on the same vertical level, and preferably have to be spread over several separately extractable vertical levels, and more preferably being so narrow throughout its height that acquired distribution with respect to flake size will be spread across such a considerable vertical span that a desired flake size easily can be extracted from a specific vertical level;

said flakes characteristics in combination with said bubble former 10-characteristics being of such levels that the repelling forces between the particles increase enough, for the separation between the particles to be sufficient to allow natural redistribution with respect to the particles floatability; and also sufficient to separate particles of different floatability to spread across different vertical levels, whereby the particles flake size can be distinguished by their vertical position after aerating the dispersion for a sufficient amount of time.

In some embodiments, the system from previous or similar, can be used to perform the process as described before, but further comprising the following:

a) the flakes particles characteristics comprising the feasibility of encountering a bubble as well as attachability to the bubbles, both positively affecting the possibility of a particle attaching to a bubble, in combination being such that the flakes floatability is increasingly dependent on increasing flake-size;

b) the container 14 has a upper part 44, at a vertical span continuously traversing down from the liquid surface, wherein the containers inner horizontal cross-sections area is so small in size that flakes with positive floatability have to be spread over several vertical levels, and preferably have to be spread over several separately extractable vertical levels, and more preferably being so narrow throughout it's height that acquired distribution with respect to flake size will be spread across such a considerable vertical span that a desired flake size easily can be extracted from a specific vertical level,

and/or

the liquid container 14 has a lower part 42, at a vertical span continuously traversing up from the container bottom, wherein the containers inner horizontal cross-sections area is so small in size that flakes with negative floatability have to be spread over several vertical levels, and preferably have to be spread over several separately extractable vertical levels, and more preferably being so narrow throughout it's height that acquired distribution with respect to flake size will be spread across such a considerable vertical span that a desired flake size easily can be extracted from a specific vertical level;

said flake characteristics in combination with said injection-characteristics being of such levels that the repelling forces between the particles increase enough, for the separation between the particles to be sufficient to allow natural redistribution with respect to the particles floatability; and also sufficient to separate particles of different floatability to spread across different vertical levels, whereby the particles flake size can be distinguished by their vertical position after aerating the dispersion for a sufficient amount of time;

wherein the percolating is continued suitable time for an equilibrium to be reached, whereby flakes will be vertically distributed across a suitable vertical span in the container. This preferably means for 2-6 hours, more preferably for 3-5 hours or about 4 hours depending on the height of the container.

Process 1

A working cycle of the technique using simplified drawings describing an embodiment wherein the technique is applied on graphene oxide flakes.

A process for separating dispersions graphene oxide flakes, or equivalent, with specific flake size, said process comprises the steps of:

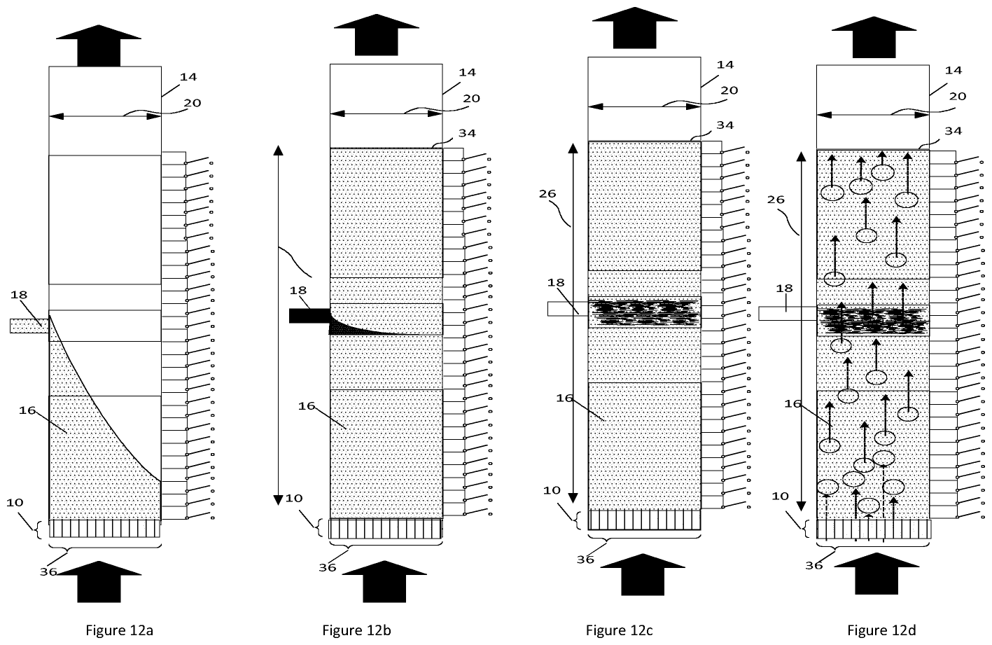

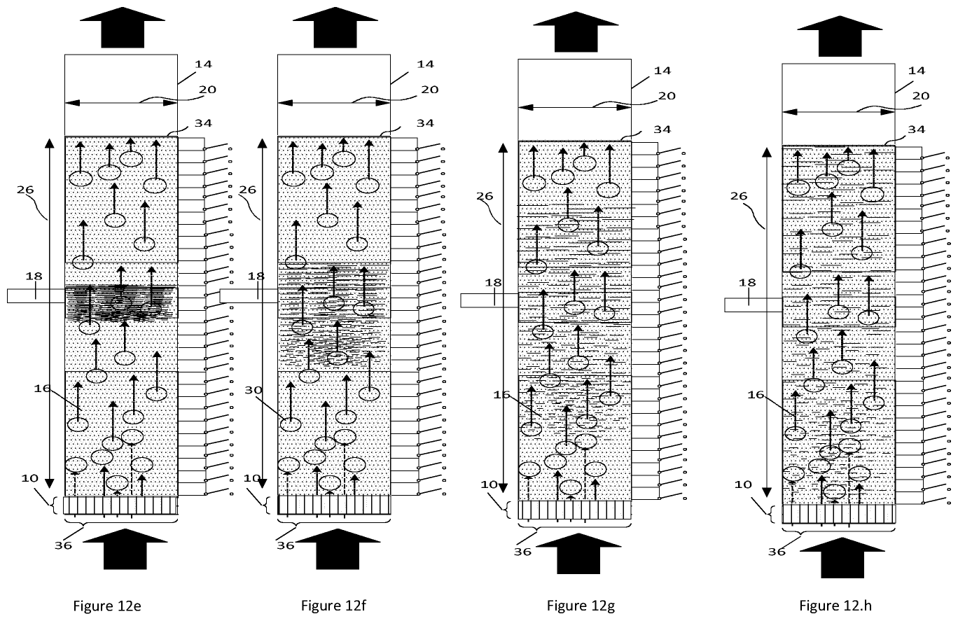

Starting with an empty container 14 as in FIG. 12.a

Referring to FIG. 12b, supplying an aqueous dispersion of substantially single layered graphene oxide flakes with varying flake size, into a container 14, the liquid being of lower density than the flakes, creating a volume of said aqueous dispersion 16.

Referring to FIG. 12c, at initial state flakes 28 of different surface area randomly distributed across the volume.

Most flakes tend to sink before, the bubbles start to force the graphene oxide flakes 28 upwards. On the other hand, graphene oxide flakes have somewhat odd flotation properties

Apply ultra-sonic treatment on the dispersion for approximately 30 minutes. The Graphene Oxide dispersion of substantially single layered graphene oxide flakes with varying flake thickness will, after that, turn into a substantially Single Layer Graphene Oxide Dispersion. A property possibly affecting the characteristics of attachability, namely “varying thickness”, is removed. Thus leaving substantially only the flake property of “flake size”, to affect the bubble-flake attachability. Other treatment that serves the same purpose as ultra-sonic can also be used.

Referring to FIG. 12d, After supplying the liquid dispersion 16, now supplying a stream of gas bubbles to the dispersion (aeration), with the bubbles moving upwards, from a vertical position below said certain vertical position; evenly disposed across a horizontal cross-section at said certain vertical position, defined by the inner side walls of the container. The microbubbles are being evenly distributed. The bubbles shouldn't constantly cover exactly the whole horizontal cross-section, since that would press substantially all flakes upwards and that is not the objective. Nor should it run so slow that all flakes sink. The objective is to separate the flakes vertically according, their flake-surface-area-property, making large flakes 38 want to move slowly upwards and making small flakes 40 move slowly downwards, thus separate them. Therefore the stream properties velocity, amount and size of the bubbles should be such that they have the possibility of passing by said flakes as well as encounter and attach to the flakes, and thereby bring them upwards; and wherein the combined stream and flakes properties being such that larger flakes averagely have proportionally more time interacting with the bubbles, such that larger flakes 38 move upwards more than the smaller flakes 40 and therefore faster create populations higher up in the container 14. What happens is that the larger flakes due to this get higher floatability and likely also higher average velocity (according to earlier definition). Further description of this is omitted here since it's considered to be well covered earlier in the patent.

Tested and well-functioning settings can be as following: a system characterized in that:

the liquid-container 14 have a preferred proportion between the cross-section-diameter:height, ranging between 1:10 and 1:100;

the initial concentration of graphene oxide in the dispersion, range between 1 g/L and 10 g/L;

the relation inlet pressure:outlet pressure of the system, ranging between 2:1 and 3:2;

the flake size, range of diameters being between 0.2 μm and 100 μm; and

the inlet pores 32 for gas preferably have a cross-section area, ranging from 10 nm² and 10 mm².

Furthermore it is recommended that the direction should be strictly vertical (upwards), for the distribution of the population of flakes to display a reliable result. The distribution distributed one dimensionally over different distances almost solely depending on the property of flake size-variations in the flake-population. The flake size indirectly affecting the average velocity in said one-dimensional direction. With this in mind it is likely that any misdirected bubble flow, might give misleading results, since it might make this increased velocity pointing in the wrong direction. Therefore any turbulence in the bubble flow might affect the quality of the result, since a flake following a bubble thereby might follow said bubble in the wrong direction and thereby give misleading results. Any bubble flow pointing in other directions than up will counteract the bubbles natural flow, and therefore being a source for turbulence. To avoid turbulence it is also important that the inlet-pores point in the same direction and that the inner walls are smooth etc. To summarize: avoiding turbulence is important.

Referring to FIG. 12e, using recommended settings described in before, so it can be seen that, after a certain amount of time likely being several hours, populations of larger surface areas are beginning to densify higher up in the container. Populations of smaller surface areas are beginning to densify lower down in the container 14. Still, the separation into the continuous distribution isn't yet distinct enough. To get a better separation one only needs a higher container.

Referring to FIG. 12f, after supplying said stream of gas bubbles for a time. The time, being suitable for flakes to be vertically distributed across a suitable vertical span in the container. With the recommended settings above, recommended time to run these steps 5b-5d, preferably means for 2-6 hours, more preferably for 3-5 hours or about 4 hours. By now the flakes are distributes well and only a small fraction of the flakes are in an erroneous population. The system is dynamically stabilized and flakes are separated. There is no point to continue aeration. To understand what is actually happening in sections above, please refer to the Table and FIG. 6a-n.

Referring to FIG. 12f, after this it is preferred to wait 10 min to let any turbulent flows inside calm down. Where after it's time to take the samples. This is performed by extract a liquid volume from a restricted range at a vertical position of desired flake size, to a desired destination. If the bubble stream is turned off, the flakes will eventually sink. It is therefore recommended that liquid extraction is performed within 15 minutes. When in combination of the settings above.

Referring to FIG. 12f-12i, it describes one out of many different ways of, extracting a liquid volume from a vertical position of desired flake size. In this example there is an array of outlets 52 in a vertically disposed along the side wall of the container, refer to FIG. 10 for a larger drawing of the same. Since the flakes by now are continuously distributed, with particles of substantially the same flake size on each horizontal span, having a lower variance than initially. If you extract only that span you get substantially only those flake sizes. In the drawings (FIG. 12f-12i) this is solved by connecting opening of specific vertical positions to a destination of lower vertical level. Whether bubbles are kept on or off: discharge of all a liquid volumes from each vertical position is performed, by using openings on the side walls. Starting with the top level, and then connecting them one by one, in a descending order, not connecting the next one before the previous one is emptied and so on. In FIG. 12g the top part of the container is already emptied. In FIG. 12h a few more parts are emptied, and in FIG. 12a all of the container is empty. For simplicity reasons the different containers are connected using valves illustrated as switches, but obviously it is actually valves. In summary this extraction technique can be described as: the device comprises at least two valves, in fluid connection with the container, said valves being situated at different vertical levels of the container.

wherein said extracting comprises extracting a first flake fraction by extracting the liquid dispersion down to a first vertical level in the container, and subsequently extracting a second flake fraction by extracting the liquid dispersion down to a second vertical level in the container.

Several other alternatives extraction techniques are possible, for example:

The system above can be described an extraction device performing an extraction method, wherein the extraction device comprises an array of openable outlets positioned at different vertical levels, the array comprising at least one outlet, wherein each outlet is periodically connected, possibly via a valve to a destination, via a container-drainage-devise. The container-drainage-devise can be represented by a passage connected to a vertically lower destination, as described above. The container-drainage-devise can also be represented by a pump that pumps away the liquid from each outlets wherein each outlet position.

The extraction device or extraction method can also comprise a holder controlling the vertical height, possibly with movable horizontal walls covering one or more horizontal cross-sections, at different vertical positions within the container, sealing a limited vertical level of the container, from where the outgoing liquid dispersion of a specific flake size, can be pumped out.

The extraction device or extraction method can also comprise rapid freezing of the liquid in the container or arrangement of the vertical valves every said 2 cm of the container.

The procedure can be done with the bubble flow kept on, while taking samples. If a dynamic equilibrium is reached, this should give more time to empty the container, than turning the flow off. If emptying the container after running according to the technique of the drawings in FIG. 12a-12h, it is more difficult to tell which way is preferred.

Referring to FIG. 12i, the last step of the cycle is reached. The container is emptied. In the next step the container will be filled again.

### Second Embodiment

In some embodiment, as with aqueous dispersions of graphene oxide flakes: the average time the gas bubbles and graphene oxide flakes and the average time they stay attached is positively dependent to the flakes flake size. Thus, the larger the flakes, the longer times they interact and therefore are carried up for longer periods. In this case it sometimes means, that the average upward velocity of larger flakes, are higher than for smaller flakes. The average upward velocity is defined as distance moved over a longer period of time. This therefore also means that after a certain period of time, the larger flakes should have reached higher above their initial positions compared to the smaller ones.

Within this dispersion, the bubble settings are such that at least larger flake sizes have an average velocity upwards. Other flake sizes might have an average velocity downwards, and some an average velocity of zero, but preferably all move up and down alternatingly. All flake sizes with an average velocity upward, progress in that direction, however slowly that might be. The progress comprising ascending and sinking alternatingly, but the larger flakes ascend proportionally larger part of the time. Equivalently all flake sizes with a negative average velocity, slowly progress downwards.

It should therefore be possible to differentiate/select/distribute certain nanoparticles from each other by their average velocity, which during certain bubble-characteristics and nano-material-characteristics, is positively dependent with respect to the flake size. By measuring how far they have traveled after a certain amount of time, from a common start vertical position, and then pic particles from specific verticals positions this would be achieved. Even in circumstances where the average velocity dependency with respect to the flake size isn't reliable enough to differentiate/select/distribute certain nanoparticles from each other by their average velocity, it can still be a good idea to start from a common vertical position. As can be seen above, even if redistribution works it takes time. If large flake sizes usually have higher average upward velocity, they have a higher possibility of getting above small flake sizes from the start. Thus more flakes will be placed correctly, early in the process, whereby less time is needed for redistribution.

In some embodiments this is therefore utilized:

A flotation system and the liquid container 14 further comprising:

an upper part 44, at a vertical span continuously traversing down from the liquid surface; and/or

a lower part 42, at a vertical span continuously traversing up from the containers bottom;

a middle part 46 positioned between the lower part 42 and the upper part 44 comprising an inlet for injecting liquid dispersion 16 of concentrated nanomaterials, to a substantially specific vertical position; and

at least one particle sensor, for detecting nanomaterial particles placed at a vertical position near the liquid surface;

wherein the system is arranged to, inject liquid dispersion 16 of concentrated amount of particles (possibly two-dimensional solvable nanomaterial particles like GO-flakes) into the middle part 46, supplying microbubbles with the gas-injector until the particle sensor detects a sufficient amount of particles, extract liquid volumes from different vertical spans in the container.

The flake material may here be introduced into the liquid at a quite specific vertical level. The middle part 46 can advantageously be placed at a vertical level which is between the bottom and the liquid surface of the container, and the flake material may be introduced into the liquid in the form of a supply liquid dispersion wherein at least some of the flake material have a higher concentration than the liquid dispersion processed in the container.

The system described can be used to perform the process, but further characterized in:

the nanomaterials particles characteristics comprising the feasibility of encountering a bubble as well as attachability to the bubbles, both positively affecting the possibility of a particle attaching to a bubble, in combination being such that the nanomaterials floatability is increasingly dependent on flakes increasing flake size;

the liquid container 14 has a upper part 44, at a vertical span continuously traversing a distance down from the liquid surface;

and/or

the liquid container 14 has a lower part 42, at a vertical span continuously traversing a distance up from the container bottom;

a middle part 46 positioned between the lower part 42 and the upper part 44 comprising an inlet for injecting liquid dispersion 16 of concentrated nanomaterials, to a substantially specific vertical position; and

Wherein said injection of liquid dispersion 16 is of concentrated graphene oxide and enters the container 14 via the middle part 46 inlet;

the microbubbles are supplied until a sufficient amount of particles has reached either the bottom or the liquid surface, whereby the particles flake size can be distinguished by their vertical distance from the middle part 46;

move liquid volumes from the different vertical spans in the container, to separate destinations.

In some embodiments, not necessarily preferred embodiments, but well tested. a device for separation of graphene oxide flakes based on their size comprise a vertically elongated container of cylinder shape, having the ratio of diameter:height ranging between 1:4 and 1:20. The container can be made of glass or any other material inert to the media. In the process the container has been filled by approximately 80% with liquid containing 95% of single layer graphene oxide flakes of lateral dimension from 0.05 to 100 micron, e. i. a polydispersion with a concentration ranged from 1 to 10 g/L. The dispersions have been based on deionised water, which may contain other solvents for necessary density tuning. Obviously an important part of the system are the gas bubbles, air bubbles introduced from the bottom of the container through tiny nozzles—pores—of specific diameter of having a diameter of 0.1 to 1 μm or 1 to 30 μm, preferably 1-20 microns or 5-10 microns, wherein the porous surface has a porosity of 0.1-10% by area and 1 to 10, or 10 to 100, or 100 to 1000 openings per mm². Through the nozzles the gas bubbles are supplied in an amount of 5 to 25 ml/min/cm² of cross-sectional area of the container.

In the described device, gas bubbles ascending from the bottom to the top, are interacting with the graphene oxide flakes, causing their movement up, while due to the gravity flakes tend to move down. Due to the different probability of gas bubbles interacting with the flakes of different size, after certain time a dynamic equilibrium is reached in the container. In this equilibrium the graphene oxide flakes are redistributed in a way so that large flakes are at the top and smaller in the bottom, with a constant gradient of the flakes size throughout the container height.

### Process 2

Referring to FIG. 12, as described earlier, using an container 14 with a gas bubble former 10 at the bottom, supplied with gas from said gas supply 12; said bubble former arranged to supply gas bubbles into the container 14 via a multitude of upwards vertically directed bubble beams from a multitude of input positions uniformly distributed across a horizontal cross-section, each bubble entering randomly from one of the input positions with substantially the same probability; bubbles supplied with an bubble former-characteristics comprising bubble-frequency, bubble-velocity, input position spacing and bubble-size; the characteristics being such that there is a possibility for each flake nanomaterial 28 to be encounter and attach to a bubble as well as a possibility of not attaching, detaching or being missed, but when attaching to a flake being able to ascend with said flake; and a gas output for expelling the injected gas, placed above the liquid-surface in the container, thereby making the bubble ascend from the bottom towards the surface, wherein the nanomaterial dispersion is polydisperse with respect to flake size but have a substantially uniform thickness on the order of nanometers (at least after processing the material), with the nanomaterials flakes characteristics comprising the feasibility of encountering a bubble as well as attachability to the bubbles (as with nano-sized flakes of GO), both positively affecting the possibility of a flake attaching to a bubble In these situations the specific bubble former-characteristics and nanomaterial characteristics in combination can be set so that the nanomaterials average velocity is increasingly dependent on increasing flake size. Also these nanomaterials characteristics in combination with said injection-characteristics can be of such levels that the difference in flake size is, apparent in the dependent characteristic of nanomaterials average velocity. In these circumstances the difference in velocity can obviously be measured by measurement of distance moved.

Due to the above, a working cycle of a second embodiment, using simplified drawings, describing an embodiment wherein the technique utilize the flakes average velocity, and use this to distribute the flakes, is applied on graphene oxide flakes. The technique will now be described in a process comprising several process-steps with reference to FIG. 12.a-h. FIG. 12.a-h illustrates a working cycle of the technique using simplified drawings. No claims are on accuracy of flake size, flake density etc. The drawings are merely of caricature type. The steps of Process 2 are simplified compared to process 1 since a lot of the content is equivalent to process 1.

In the illustrated process 2, the liquid container 14 has a upper part 44, at a vertical span continuously traversing a distance down from the liquid surface. In the embodiment illustrated here, the liquid container 14 also has a lower part 42, at a vertical span continuously traversing a distance up from the container bottom. Furthermore, there is a middle part 46 positioned between the lower part 42 and the upper part 44 comprising an inlet for injecting liquid dispersion 16 of concentrated nanomaterials, at a substantially specific vertical position, comprising an inlet for injecting liquid dispersion 16 of concentrated nanomaterials, to said substantially specific vertical position.

A process for redistributing graphene oxide flakes with varying surface areas in a dispersion, said process comprising the steps of:

a) Referring to FIG. 12.a, injecting a liquid without graphene oxide flakes, into a container 14, almost filling the container. The flotation system can be of the same type as the one used in process 1, it should have a input fairly central, vertically.

b) Referring to FIG. 12a-12b, injecting a liquid dispersion 16 graphene oxide flakes with varying surface areas, into the container 14, creating a concentrated liquid dispersion 16 volume, the liquid being of lower density than the flakes. The injection of liquid dispersion 16 is of concentrated graphene oxide and enters the container 14 via the middle part 46s inlet. Since this embodiment measures the velocity by measuring how far the particles moved, and thereby measure the flake sizes, it is important to have a common start position. Otherwise it is difficult to tell the velocity. Furthermore, since the dispersion is supplied to a smaller region, a higher concentration needs to be supplied in process 2 than in process 1, to get the same concentration out.

c) If necessary, process the graphene oxide flakes until they are substantially single layered (not illustrated).

d) Referring to FIG. 12a, supplying a stream of gas microbubbles, moving upwards, from a vertical position below said certain dispersion volume, streams evenly disposed across a horizontal cross-section at said certain vertical position, defined by the inner sidewalls of the container wherein the, amount and size of the bubbles, being such that bubbles have the possibility of passing by the flakes 28 as well as encountering and attach to the flakes 28, and thereby bring them upwards, and wherein the combined stream and flakes properties being such that larger flake sizes 38 averagely have proportionally more time interacting with the bubbles, thereby the larger flake sizes 38 move upwards for a proportionally larger amount of the time. In this embodiment you don't wait for the particles to reorder according to their flake size. You just wait for the large particles to move away upwards from the smaller ones, due to their higher velocity. The particles with positive velocity will spread away from each other into upper part 44. At the same time the particles with the lowest floatability (negative) will sink faster than the others. Particles with negative floatability will in the same manner spread away from each other into the lower part 42. The process is illustrated in FIG. 12a-12h.

e) Referring to FIG. 12a-12h, supplying said stream of gas bubbles for a suitable time, for flakes 28 to be vertically distributed across a suitable vertical span in the container; the microbubbles are supplied until a sufficient amount of particles has reached either the bottom or the liquid surface 34, whereby the particles flake size can be distinguished by their vertical distance from the middle part 46. In this embodiment, substantially the same characteristics are utilized, but since the particles here starts from substantially the same vertical position, there is not the same need to let the flakes 28 redistribute. Furthermore, due to how much less concentrate the dispersion gets after this process, it is likely the redistribution would not work anyway. The drawback of this embodiment compared to process 1, is lesser output particle concentration. The advantage is that there is less need to let the particles redistribute, possibly making the process faster.

f)

Whether you use the system, described above, to run a process similar to process 1 or process 2, you can easily refine the distribution using simple measures. You can for example use extra elongated containers. You can combine this type of filtering/distribution with regular filtering, assume you put a regular filter in the conduit leading to the externa destination, from the upper part 44 output. Use large pores in that filter to avoid, clogging. The small particles that somehow made their way up there will fall through, and can for example be returned back to the container and run again. Since there are large pores and very few small particles there should be less clogging.

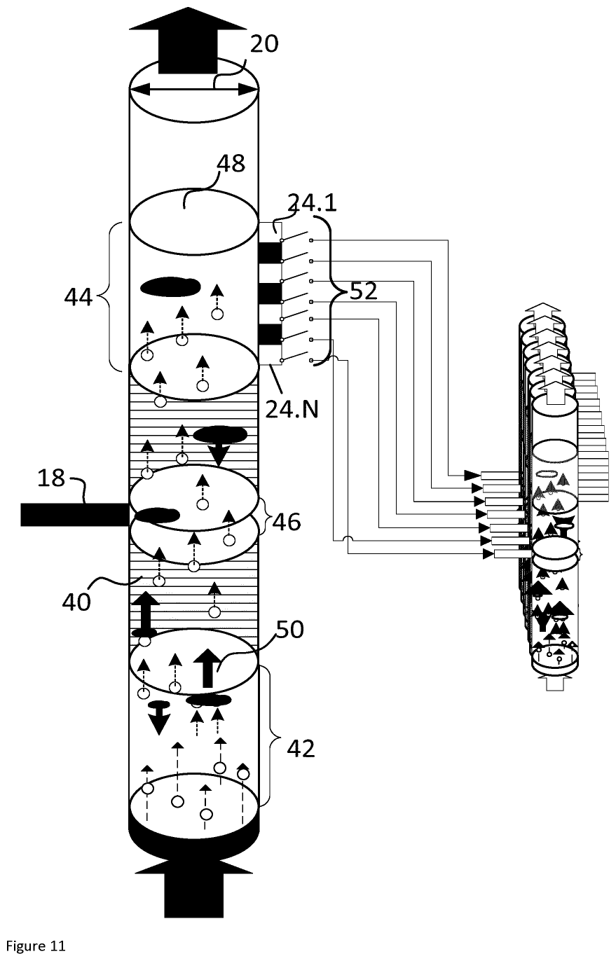

Maybe a better way though, is to use the systems in several steps (se FIG. 11). The output from the top output can be directed to another smaller apparatus, to refine the continuous distribution, so that ex only the flakes between dimension 90 and 100 microns are redistributed. In this, the second smaller apparatus, you can use a bubble former characteristics such that, any flakes of sizes smaller than said top output should have, will have a negative buoyance so that they sink, and possibly gets led back to the original container. In this way you can get a refined distribution as well as recursive filtering so that there is a very small chance that erroneous sizes will end up in the wrong destinations.

The whole process performed by a first system according to either one of the embodiments described above, would further comprise subjecting an extracted flake fraction to a second redistribution step 56 comprising:

providing a second liquid dispersion of the flake fraction in a second liquid,

arranging the second liquid dispersion in a second container,

percolating gas bubbles upwardly through the second liquid dispersion, for a time sufficient to allow the flake material in the second liquid dispersion to redistribute itself in the second liquid with larger flake sizes 38 higher up in the liquid and smaller sized flakes lower down in the liquid, and

extracting at least one of the flake fractions from a limited vertical level of the second container.

1. A method for redistributing a flake material, in particular a two-dimensional nano flake material, into at least two flake size fractions, each of which having smaller flake size variance than the flake material, the method comprising:
providing a dispersion of the flake material in a liquid, wherein the flake material is not atomized in the liquid,
arranging the dispersion in a container,
percolating gas bubbles upwardly through the dispersion, for a time sufficient to allow the flake material to redistribute itself in the liquid with larger sized flakes higher up in the liquid and smaller sized flakes lower down in the liquid, and
extracting at least one of the flake fractions from a limited vertical level of the container.

2. The method as claimed in claim 1, wherein the flake material presents an average thickness of 0.1 to 2 nm.

3. The method as claimed in claim 1, wherein the flake material presents an average flake size, as measured by flake surface area, in the range of 25 to 2500 nm².

4. The method as claimed in claim 1, wherein the flake material presents a flake lateral dimension to thickness ratio of about 50-500.

5. The method as claimed in claim 1, wherein the flake material has a density which is equal to or lower than a density of the liquid.

6. The method as claimed in claim 1, wherein the flake material has a density which is equal to or higher than a density of the liquid.

7. The method as claimed in claim 1, wherein the flake material consists essentially of graphene and/or graphene oxide.

8-9. (canceled)

10. The method as claimed in claim 1, wherein the liquid comprises water.

11. The method as claimed in claim 1, wherein the flake material is present in the liquid in an amount corresponding to 1 to 4 g/dm³ of the liquid.

12. The method as claimed in claim 1, wherein the gas bubbles present an average diameter of 200 nm-100 μm on release to the dispersion.

13. The method as claimed in claim 1, wherein a flake size to gas bubble size ratio is 0.00005 to 0.025, preferably 0.025.

14. The method as claimed in claim 1, wherein the gas bubbles are supplied in an amount of 5 to 25 ml/min/cm² of cross-sectional area of the container.

15-16. (canceled)

17. The method as claimed in claim 1, wherein said extracting comprises extracting a first flake fraction by extracting the liquid dispersion down to a first vertical level in the container, and subsequently extracting a second flake fraction by further extracting the liquid dispersion down to a second vertical level in the container.

18. (canceled)

19. The method as claimed in claim 1, further comprising subjecting an extracted flakes fraction to a second redistribution step comprising:
providing a second liquid dispersion of the flake fraction in a second liquid,
arranging the second liquid dispersion in a second container,
percolating gas bubbles upwardly through the second liquid dispersion, for a time sufficient to allow the flake material in the second liquid dispersion to redistribute itself in the second liquid with larger sized flakes higher up in the liquid and smaller sized flakes lower down in the liquid, and
extracting at least one of the flake fractions from a limited vertical level of the second container.

20. The method as claimed in claim 1, further comprising:
estimating a flake size or flake size distribution at a selected vertical level in the container,
determining whether the flake size or flake size distribution meets a criterion, and if not, then:
agitating the dispersion in at least part of the container,
repeating the percolating step,
repeating the estimating step and
repeating the determining step.

21. The method as claimed in claim 20, wherein agitating the dispersion comprises stirring the dispersion.

22-34. (canceled)

35. The method as claimed in claim 1, wherein the flake material has a density which is 70%-100% of the density of the liquid.

36. The method as claimed in claim 1, wherein the flake material has a density which is 100%-150% of the density of the liquid.

37. The method as claimed in claim 20, wherein agitating the dispersion comprises vibrating the dispersion.

38. The method as claimed in claim 20, wherein agitating the dispersion comprises adjusting a supply parameter of the gas bubbles.
